(19) United States
(12) Patent Application Publication
(10) Pub. No.: US 2004/0006501 A1
(43) Pub. Date: Jan. 8, 2004

(54) Method for maximizing manpower utilization

(76) Inventor: Rafael Aviyants, Manchester, NH (US)

Correspondence Address: Joseph E. Funk, PO Box 661, Londonderry, NH, 03053, US

(21) Appl. No.: 10/190,209

(22) Filed: Jul. 5, 2002

(51) Int. Cl. G06F 17/60

(52) U.S. Cl. 705/8

(57) ABSTRACT

A method is disclosed for optimizing the provision of temporary short and/or long term manpower within a company in a cost efficient manner. Following a study of the historic demands for temporary services within different parts of a company, and a financial analysis of the provision of such temporary services with full time versus part time employees versus the skills to be provided, a new group of full time employees and part time temporary help with predetermined skills is assembled to serve as a temporary manpower resource pool to different organizations within the company. The abilities of members of the new group are assembled into a database along with information as to what company locations a person can work in, their skill sets, the hours they can work, and other pertinent information. As managers within the company require short or longer term temporary help to meet manpower demands, they first consult either a group managing the new group of temporary manpower resources and/or the database and input their requirements. The requirements are compared to information in the database and a list of potential candidates is obtained. After a manager identifies one or more candidates that can meet their temporary manpower requirements they can either contact the candidates themselves or have the managing group do so and arrange for obtaining the services of a candidate.

### FIELD OF THE INVENTION

This invention relates to a method for managing human resource allocation.

### BACKGROUND OF THE INVENTION

Large companies or businesses having multiple facilities around a specific metropolitan area, and/or in different states and countries often have demands for “temporary” manpower to handle overflow work of short term duration that may be days or weeks, and to staff specific longer term projects of months or years duration after which the manpower may not be needed.

Such staffing demands within the corporate environment can be a formidable task for managers who do not have the time to handle such matters. Managers are responsible for identifying and securing employee or external consultants to service varied project requirements. Conventionally, a manager will use a personal list of resources and the contact with a resource is usually by telephone. Because of this, “telephone tag” and dead-end leads are common and assignment of a resource to an engagement may he delayed by days. When a manager is unable to identify a resource within the manager's organization to fill an engagement, queries to other organizations within the corporation are initiated and usually by telephone and e-mail. Human resource departments similarly are not equipped to perform the extra work required to identify and obtain temporary personnel.

For such temporary manpower, human resources departments often turn to manpower agencies that have and/or obtain the people needed to fill such manpower demands. In this manner companies needing temporary manpower may quickly and easily fulfill such manpower requirements without all the extra work created in locating, obtaining, and handling all the paperwork for such temporary help.

However, there is an extra monetary cost to operating in this manner. The hourly or weekly cost charged by manpower agencies for temporary manpower must reflect profit and overhead costs of operating such agencies. This extra monetary cost, while offset by not having to pay employee benefits, is exacerbated by the large amount of temporary manpower typically required by a large company.

Accordingly, there is a need in the art for a way to provide temporary short and/or long term manpower within a company without incurring the significantly higher costs of manpower agencies.

### SUMMARY OF THE INVENTION

The need in the prior art for a way to provide temporary short and/or long term manpower within a large company without incurring the significantly higher costs of manpower agencies is solved by the present invention.

Within a large company, a small group—which may be part of a human resources group, will manage a group of full time employees and part time temporary help that serve as manpower resources to other groups within the company that require temporary manpower to handle overflow work of short term duration that may be days or weeks, and to staff specific longer term projects of months duration after which the manpower is not be needed.

Based on the historic demands within different parts of a company for temporary manpower resources this new group assembles a database of individuals with particular skills that are: (a) full time employees of the company that can work full time during regular business hours in different company locations in a defined area, (b) employees that can and want to work less full time and can work in different company locations in a defined area, (c) non-employee, temporary help that can work full time during regular business hours in different company locations in a defined area, and (d) non-employee, temporary help that can and want to work less full time and can work in different company locations in a defined area. Other categories may also be defined as needed, and the number and skill levels of people may vary during a year as seasonal demands dictate. The individuals in the last of the four above defined groups may include such people as retired employees and others who want to work part time with flexible hours, and college students. Other individuals may be located for inclusion in the temporary manpower database by placing advertisements in newspapers and other media as required.

The database has assembled by the above-mentioned new human resources group includes information such as what company locations a person can work in, their skill sets, the hours they can work, and other pertinent information.

As managers within the company require short or longer term temporary help to meet their manpower demands, they can call contact individuals in the new group or can directly access the database and input their requirements. The requirements may be for relatively unskilled labor up to highly skilled labor. The requirements are compared to information in the database and a list of potential candidates to fulfill their manpower needs is returned to them. When requirements received from managers are processed directly by the new human resources group a list of potential candidates is given to a requesting manager. After a manager identifies one or more candidates that can meet their temporary manpower requirements they can either contact the candidates themselves or have the new human resources group do so and arrange for obtaining the services of a candidate.

The cost savings of not dealing through external manpower agencies and the lost time heretofore spent in identifying and arranging for the services of temporary manpower more than offsets the cost of the new human resources group that oversees the temporary human resources function described above.

Further, there are financial savings to companies when such non-employee temporary help is utilized because loaded salary employee expenses and benefits for medical plans, retirement plans, vacation time and the like are saved.

Thus, temporary short and/or long term manpower requirements within a company can be determined and provided in a very cost efficient manner providing cost savings to the company.

### DESCRIPTION OF THE DRAWING

The invention will be better understood upon reading the following detailed description in conjunction with the drawing in which:

FIG. 1 is a block diagram flowchart of the steps involved in implementing the present invention.

### DETAILED DESCRIPTION

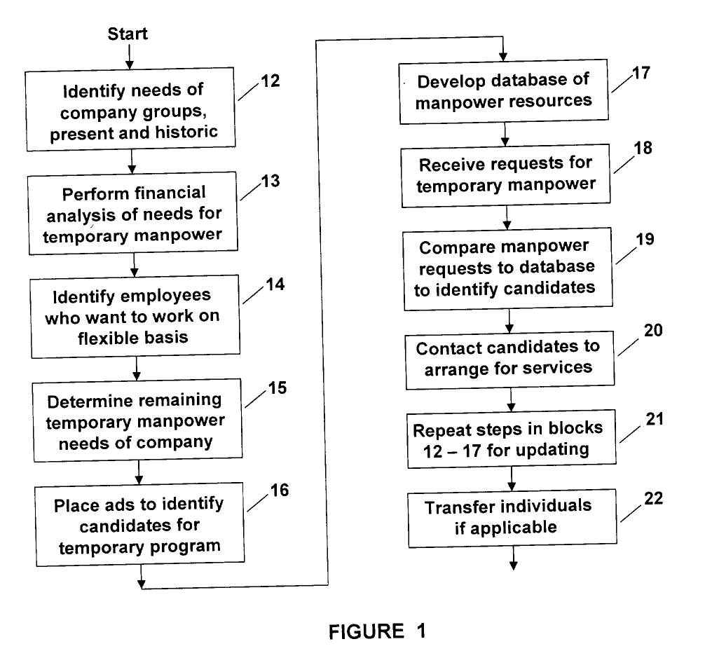

In FIG. 1 is shown a diagram flowchart of the steps involved in implementing the present invention. At block 12 the range of general to highly skilled temporary manpower needs of a company are identified and analyzed. The analysis includes changes in manpower needs over the course of each year and over multiple years.

At block 13 it is to be determined if regular employees are to be hired rather than use temporary help. This is done as a long-range financial analysis to determine if monetary savings will be achieved by utilizing different types of temporary manpower.

For example, temporary manpower who are company employees have various benefits such as, but not limited to, medical plans, retirement plans and vacation time that must be accounted for in the financial analysis. Benefits such as those are not included for temporary manpower help who are not employees of the company. As a result of the financial analyses it sometimes will be determined that the company will save money or achieve other efficiencies by hiring full-time employees at specific locations and for specific groups, rather than using temporary manpower. There are other factors to be considered when performing this financial analysis. Examples are the requirement for a security clearance or the need for a very specific skill that is utilized infrequently.

Where temporary help is determined to be validly needed at specific company locations the skill sets, experience, other factors and the amount of temporary help needed are determined by company location and by work groups in each location.

At block 14 certain company employees are identified who may wish to participate in the temporary manpower program. Such employees may, for example, have specific unique skills that are only used infrequently by the company organizations to which they are permanently assigned. Yet, their unique skills are required by other groups within the company, and it is more efficient for such individual employees to be available to provide their unique skills as required to the other groups within the company. In addition, if it is determined at block 13 that there are specific temporary manpower needs that cannot be fulfilled by non-employee temporary help, then full-time employees must be identified and assigned to the temporary manpower program. An example of this would be secretarial and clerical help who must hold security clearances.

After employees are assigned to the temporary manpower program, at block 15 the remaining temporary manpower needs of the company are determined. Rather than use temporary help agencies to fulfill such temporary manpower needs, with the attendant higher cost, the company develops a pool of non-employees who wish to provide services to the company on a temporary or part-time basis. Examples of such non-employees may be retired personnel who wish to work a relatively small number of hours each week and already have the skills and experience needed by the company. Some temporary help may only wish to work one or two days a week. Other people having needed skills may only wish to work a relatively small number of hours each week, and possibly on a flextime basis or at home. One example would be a mother with small children who wishes to work some hours every week around her children's schedules that includes the time they are in school.

To identify skilled people who wish to work part-time as described in the previous paragraph, at block 16 selective advertisements are placed in newspapers, professional journals and on radio and television, as appropriate, in areas near company locations at which particular skills are being sought. Responses received to these advertisements are used to identify candidates for the pool of temporary manpower. As demand in the company for temporary help with specific skill sets changes these advertisements are repeated or new advertisements are generated.

Periodically, or on an ongoing basis, the temporary manpower needs of the company are identified and analyzed in block 12 to assure that the temporary manpower program best serves the needs of the company.

At block 17 employees who are assigned to the temporary manpower program and non-employee candidates identified and chosen at block 16 are added to a database of manpower resources. The database includes all appropriate and necessary information about these people. Such information includes what company locations the individuals can provide service to, if they are willing to travel to more distant company locations, the skills and expertise the individuals have, the time(s) they can work, their availability, etcetera. Other appropriate information may be added to this database. Availability must be added to the database because, for example, an employee with a unique skill and in the temporary manpower program may be assigned for specific period of time to one group in the company and will not be available to other groups during that time. Availability will also cover times that people are on vacation, on maternity leave, or are sick. After the database is developed, at block 18 requests for temporary manpower are received from groups within the company by the new human resources group administering the temporary manpower program. Alternatively, managers requesting temporary manpower may be provided direct access to the database to input their requirements and view possible candidates identified from the database.

At block 19 the database software utilizes the manpower requirements input thereto to identify potential candidates in the database that meet the specified requirements. Identified candidates and the information stored in the database for each are output for review.

At block 20 either a manager requesting temporary manpower, or someone in the group administering the temporary manpower program, contacts one or more candidates identified from the database to determine their availability and other factors, if necessary, and a candidate is selected and an offer made to perform the work.

Frequently, which may be periodically, or on an ongoing basis, the needs of company groups for temporary manpower first determined in block 12, the financial analysis performed in block 13, the identity of employees who wish to participate in the temporary program made in block 14, the determination of the remaining temporary manpower needs of the company determined in block 15, the identify skilled people who wish to work part-time per block 16 and the updating of the database of manpower resources made in block 17 must be repeated in order to assure that the program continues to meet the temporary manpower needs of the company. This is done at block 21.

At block 22, depending on the changing needs of the company and the needs of individuals participating in the temporary manpower program described in this specification, some non-employee individuals participating in the program are asked and become full time employees of the company. Likewise, other individuals, such as recent retirees of the company may become non-employee participants in the program. Thus, individuals are transferred to different capacities in the program.

Over time some temporary employees working in the temporary manpower program described herein may transfer and become full time employees per block 22. Managers in the company can better evaluate if they will be a good, full time employee based on their personal experience with the individuals as temporary employees. This is very beneficial to the company and results in better employees with longer term retention.

In a variation on the novel method described herein the new temporary manpower group may also be used to provide temporary manpower to other companies, including partially or fully owned subsidiaries of the company who has the temporary manpower group.

While what has been describe hereinabove is the preferred embodiment of the invention, it will be appreciated by those skilled in the art that numerous changes may be made without departing from the spirit and scope of the invention.

What is claimed is:

1. A method for fulfilling the temporary manpower requirements of a business comprising the steps of:
(1) identifying manpower requirements of the business;
(2) analyzing the financial savings to the business of using temporary manpower for some manpower requirements of the business;
(3) recruiting individuals who are existing employees of the business who wish to work in a temporary capacity for the business;
(4) recruiting other individuals who wish to work in a temporary capacity for the business; and
(5) placing the individuals in the business to fill temporary manpower requirements.

2. The method in accordance with claim 1 further comprising the step of:
(6) developing a database of temporary manpower resources available to the business per steps (3) and (4); and
(7) comparing requests for temporary manpower resources with the database of temporary manpower resources to identify individuals who meet the requirements for individual requests.

3. The method in accordance with claim 2 further comprising the step of:
(8) determining the remaining temporary manpower requirements of the business after recruiting individual who are existing employees of the business who wish to work in a temporary capacity for the business in step (3).

4. The method in accordance with claim 3 further comprising the step of:
(9) receiving requests for temporary manpower from within the business before step (7) of comparing requests for temporary manpower resources with the database of temporary manpower resources to identify individuals who meet the requirements for individual requests in step (7).

5. The method in accordance with claim 2 further comprising the step of:
(10) frequently repeating steps (1) through (4) and (6) to best meet the temporary manpower requirements of the business.

6. The method in accordance with claim 5 further comprising the step of:
(11) transferring individuals from temporary capacity to full time employee status and visa versa based first on the needs of the company and secondarily on the assent of the individuals.

7. The method in accordance with claim 1 further comprising the step of:
(10) frequently repeating steps (1) through (4) and (6) to best meet the temporary manpower requirements of the business.

8. The method in accordance with claim 7 further comprising the step of:
(11) transferring individuals from temporary capacity to full time employee status and visa versa based first on the needs of the company and secondarily on the assent of the individuals.

9. The method in accordance with claim 1 further comprising the step of:
(11) transferring individuals from temporary capacity to full time employee status and visa versa based first on the needs of the company and secondarily on the assent of the individuals.

10. The method in accordance with claim 2 further comprising the step of:
(11) transferring individuals from temporary capacity to full time employee status and visa versa based first on the needs of the company and secondarily on the assent of the individuals.

11. The method in accordance with claim 8 further comprising the step of:
(6) developing a database of temporary manpower resources available to the business per steps (3) and (4); and
(7) comparing requests for temporary manpower resources with the database of temporary manpower resources to identify individuals who meet the requirements for individual requests.

12. The method in accordance with claim 11 further comprising the step of:
(8) determining the remaining temporary manpower requirements of the business after recruiting individual who are existing employees of the business who wish to work in a temporary capacity for the business in step (3).

13. The method in accordance with claim 12 further comprising the step of:
(9) receiving requests for temporary manpower from within the business before step (7) of comparing requests for temporary manpower resources with the database of temporary manpower resources to identify individuals who meet the requirements for individual requests in step (7).

14. The method in accordance with claim 9 further comprising the step of:
(10) frequently repeating steps (1) through (4) and (6) to best meet the temporary manpower requirements of the business.

15. The method in accordance with claim 14 further comprising the step of:
(6) developing a database of temporary manpower resources available to the business per steps (3) and (4); and
(7) comparing requests for temporary manpower resources with the database of temporary manpower resources to identify individuals who meet the requirements for individual requests.
